(19) United States
(12) Patent Application Publication
(10) Pub. No.: US 2003/0155751 A1
(43) Pub. Date: Aug. 21, 2003

(54) Safety system for occupants of motor vehicles

(75) Inventors: Alexander Aulbach, Ulm (DE); Wolfgang Siegel, Sontheim-Brenz (DE); Jens Eckle, Pfaffenhofen (DE)

Correspondence Address: FOLEY AND LARDNER, SUITE 500, 3000 K STREET NW, WASHINGTON, DC, 20007, US

(73) Assignee: TAKATA-PETRI (Ulm) GmbH

(21) Appl. No.: 10/353,069

(22) Filed: Jan. 29, 2003

(30) Foreign Application Priority Data
Jan. 30, 2002 (DE) 102 04 486.4-42

(51) Int. Cl. B60R 21/22

(52) U.S. Cl. 280/730.2

(57) ABSTRACT

A safety system for occupants of motor vehicles that includes a safety shoulder belt and an air bag module for lateral protection of the head and thorax areas of the occupants. The air bag module includes an air bag which has an area that protects an occupant's thorax and an area that protects an occupant's head. The area for the protection of the thorax includes an upper section. The area for the protection of the thorax a least extent rearward in the upper section where the safety belt also runs. The area for protection of the head is configured to extend substantially above the shoulder belt and further rearward than the upper section of the area for protection of the thorax.

### BACKGROUND

The invention relates to a safety system for occupants of motor vehicles. In particular, a safety system using at least one safety shoulder belt and with at least one air bag module for the additional lateral protection of the thorax and head area of the occupants.

For the protection of the occupants of motor vehicles it is known to use both safety belts and air bags-both front air bags to protect the occupant in the event of a frontal collision and side air bags for protection in case of a side collision. While a front air bag is not affected by the safety belt when it deploys, a deployed side seat bag, which is provided both for protection of the thorax and for protection of the head, and the safety belt interfere with one another.

To avoid this interference, European Patent No. EP 0 844 948, hereby incorporated by reference, discloses a safety system with a first chamber associated with the thorax area and a second chamber associated with the head area. There is an indentation provided in the second chamber associated with the head area by which the safety belt passes through the contours of the gas-filled second chamber. This indentation in the head chamber is intended the prevent any conflict between the inflated air bag and the safety belt.

This safety system, however, has disadvantages. With this narrow, i.e., slit-like indentation in the head area, it is not impossible to prevent the air bag and safety belt from interfering with one another when the air bag deploys. With a broader indentation the danger is that the head is insufficiently protected. The danger is further increased that the sections of the head chamber separated by the indentation will be forced apart by the head.

### SUMMARY

An object of the present invention, in the case of an air bag for protection of the thorax and head, is to reduce any interference with the airbag, especially between the portions for the safety belt and for the head, without impairing the protective action of the air bag.

One embodiment of the present invention provides a safety system for occupants of motor vehicles using at least one safety shoulder belt and with at least one air bag module for the additional lateral protection of the thorax and head area of the occupants. The safety system includes an air bag that has an area for the protection of the thorax, hereinafter called the thorax chamber, which in its upper section in which the shoulder belt passes, has its minimum rearward expansion. Additionally, the air bag has an area for the protection of the head, hereinafter called the head chamber, which reaches substantially above the shoulder belt and further rearwardly than the upper section of the thorax chamber.

The system has the advantage that, when it is deployed, the head chamber will hardly come in contact with the shoulder belt. Since the head chamber reaches further back than the thorax chamber section over which the shoulder belt passes, the belt cannot be stripped off by the deployment of the air bag. Furthermore, the protection of the head is assured thereby, even in the rearmost seat position in any type of vehicle. The size of the head chamber can easily be adapted even to different rearmost seat positions in different vehicle types. Since the head chamber has no indentation, protection of the head is reliably assured. Since the thorax chamber has its minimum rearward reach in its uppermost part, in which the shoulder belt passes, the shoulder belt and the thorax chamber hardly affect one another.

It is desirable that the head chamber be sewn off in a volute shape, while the seam which produces the volute shape extends preferably from the rear section of the marginal seam of the head chamber into the head chamber. It is also desirable that the gas inlet to the thorax and head chambers be provided in the bottom part of the thorax chamber. This brings it about that in the event of a collision, first the thorax chamber deploys, then the front portion of the head chamber, and thereafter the rear portion of the head chamber, while the air bag unfolds around the shoulder belt.

In a preferred embodiment, the tuck that produces the volute shape of the head chamber lies in a curvilinear, closed tuck which lies preferably in about the center of the head chamber. The expansion of the head chamber then takes place around this closed tuck from the front part to the rear part of the head chamber.

The curvilinear, closed tuck may be of circular or elliptical shape. Other shapes are also possible. The rear portion of the of the head chamber is designed preferably for the protection of the head.

In one embodiment the thorax chamber tapers downward continuously on its rear side toward the head chamber.

In another embodiment, the thorax chamber tapers on its rear side in the bottom section and then it runs at least approximately parallel to the front side to the head chamber.

In another embodiment the thorax chamber tapers continuously on its rear side in its lower section and then enlarges continuously back toward the head chamber.

The air bag may be fastened either to the seat, to the seat back, to a post of the vehicle, or to a door of the vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a side view of an embodiment of the present invention showing the driver's side with a deployed air bag plus the course of the safety belt.

FIG. 2 is a side view of an embodiment of the of the present invention showing an air bag with a continuously tapered rear side.

FIG. 3 is side view of an embodiment of the present invention showing an air bag with its rear side running approximately parallel to the front side.

FIG. 4 is a side view of an embodiment of the present invention showing an air bag with an oval rear side.

FIG. 5 is a side view of an embodiment of the present invention showing an oval tuck in the head chamber.

FIG. 6 is a front view of an embodiment of the present invention showing a passenger seat with a deployed air bag.

### DESCRIPTION

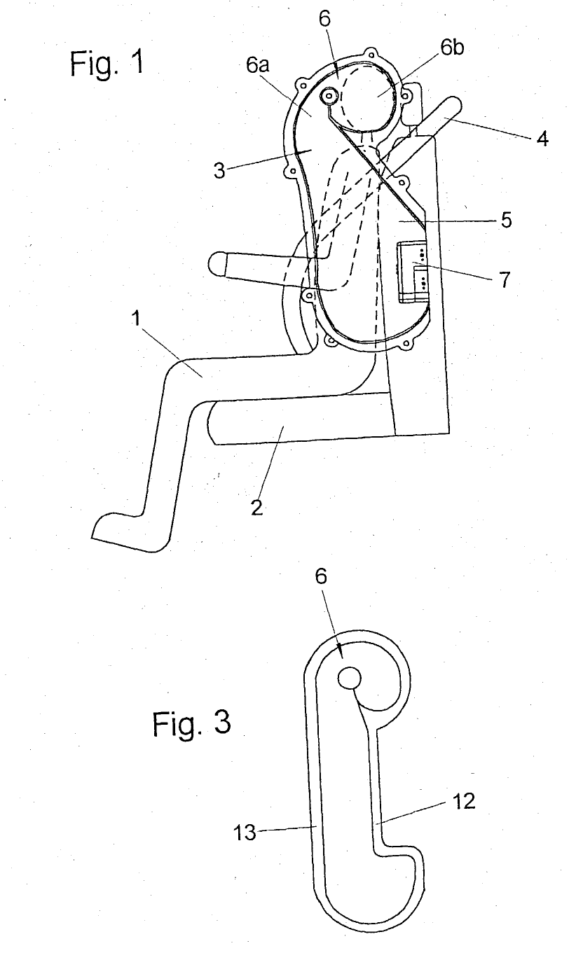

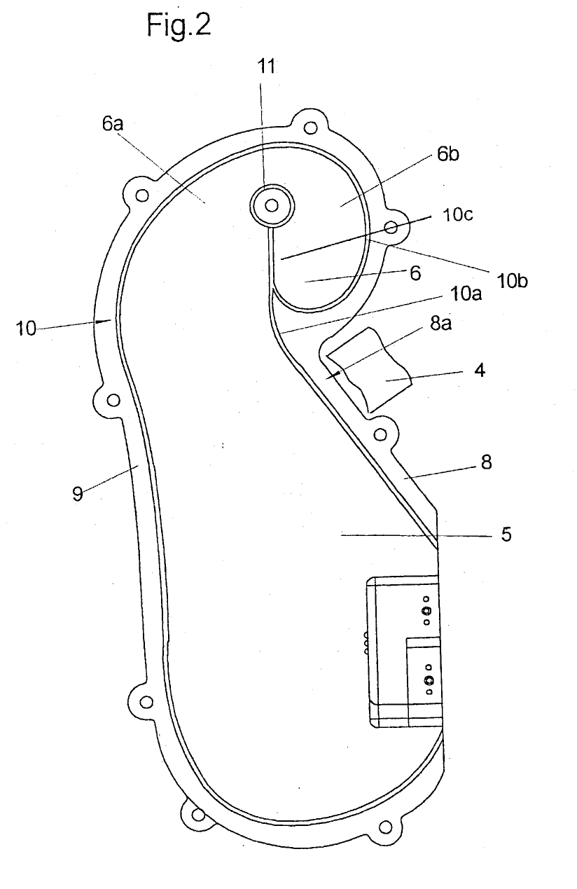

FIG. 1 discloses an occupant together with the deployed air bag and the safety belt as seen from the driver's entrance side. The driver 1 is protected on his seat 2 by an air bag 3 and a safety belt 4. The air bag 3 is represented in its deployed state. It has a thorax chamber 5 and a head chamber 6. The thorax chamber has a gas inlet in its lower part, the corresponding gas generator 7 with the air bag 3 being fastened in this embodiment to the back of the chair 2. As it can be seen especially from FIG. 2, the rear side 8 of the thorax chamber tapers continuously with respect to the front side 9 to the head chamber 6. As shown in FIG. 2, the safety belt 4 runs over the air bag at the location of the thorax chamber where the thorax chamber expands rearward to the least extent.

The air bag in the embodiments of FIGS. 1 and 2 consists of two parts, of which only that part that faces the car door is visible. The parts are joined together by a marginal seam 10. As it can be seen especially in FIG. 2, at the rear side of the air bag 3, a seam section 10a of the thorax chamber 5 and a seam section 10b of the head chamber 6 terminate at a circular tuck 11, which is provided approximately at the center of the head chamber 6. The seam section 10b runs in an arcuate section 10c such that the head chamber 6 has a volute shape. The seam sections 10a and 10b as well as the tuck 11 divide the head chamber 6 into a front section 6a and a rear section 6b.

In the case of a collision, first the thorax chamber 6 deploys upwardly from below. Then the front section 6a of the head chamber deploys. At the end the rear section 6b of the head chamber 6 fills up with gas around the circular tuck 11. As can be seen in FIG. 2, the air bag inflates around the safety belt 4. Any interference between the belt and especially the head chamber 6 is largely prevented. As can be seen in FIG. 1, it is the rear section 6b of the head chamber 6 that is chiefly intended for the protection of the head.

FIG. 3 shows another embodiment of the air bag of the present invention. As shown in FIG. 3, this air bag the rear side 12 of the thorax chamber 5 tapers in the lower section and then runs at least approximately parallel to the front side 13 up to the head chamber 6.

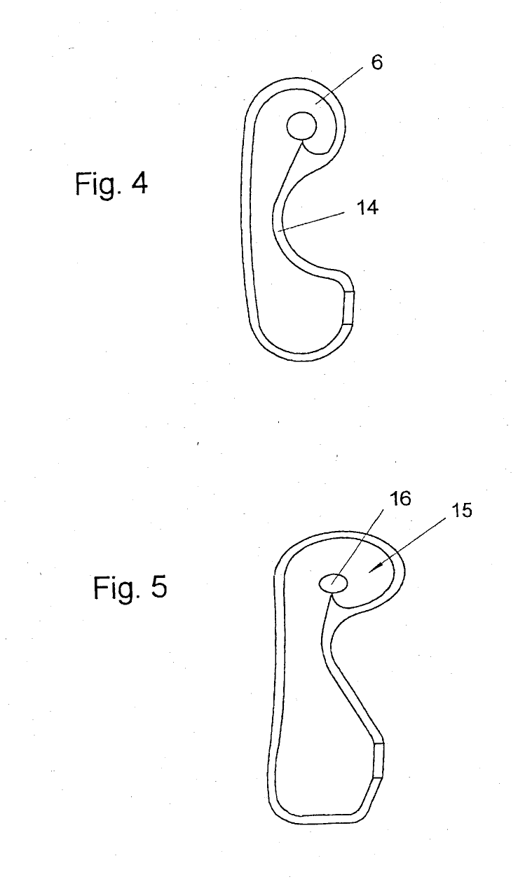

According to another embodiment of the present invention, shown in FIG. 4, the air bag may have an oval rear side 14 so that the aim of reduced interference between belt and air bag is also achieved.

According to another embodiment shown in FIG. 5, a head chamber 15 extends farther toward the rear than in the preceding embodiments. In this embodiment an elliptical tuck 16 is provided. It is also possible, of course, in the case of this elongated head chamber 15, to provide a circular tuck. It is apparent that the possible variable rearward expansion of the head chamber can easily be adapted to different vehicles with different rearmost positions of the seat.

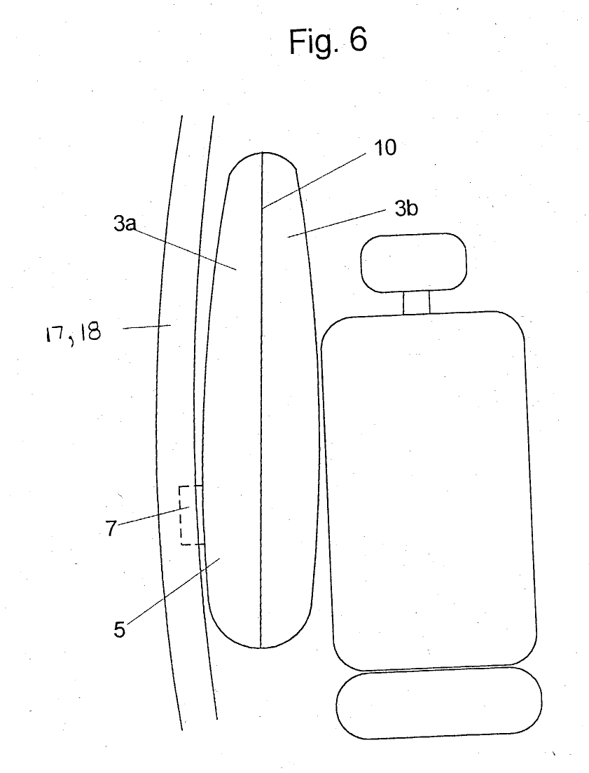

The embodiment of FIG. 6 shows the binding of the air bag 3 to the vehicle door 17 or to the B-pillar 18 on the passenger side. The gas generator 7 is likewise connected to the air bag in the bottom part of the thorax chamber 5. It can be seen in this figure that, as described above, the air bag consists of two parts 3a and 3b which are joined together by the seam I 0.

The priority document, DE 102 04 486.4-42, filed on Jan. 30, 2002, is incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A safety system for an occupant of a motor vehicle, comprising:
a safety shoulder belt;
an air bag for protection of the head and thorax areas of the occupant, wherein the air bag includes an area for protection of the thorax and an area for protection of the head;
wherein the area for protection of the thorax includes an upper section, and wherein the upper section includes a rearward extent configured to permit the safety belt to run uninhibited; and
wherein the area for protection of the head is configured to extend substantially above the shoulder belt and further rearward than the upper section of the area for protection of the thorax.

2. The safety system of claim 1, wherein the area for protection of the head is in a volute shape.

3. The safety system of claim 2, wherein the area for protection of the head includes a seam that produces the volute shape and a hem, and wherein the seam extends from a rear section of the hem into the area for protection of the head.

4. The safety system of claim 2, wherein the area for protection of the head includes a seam that produces the volute shape, and wherein the seam terminates in an arcuate tuck.

5. The safety system of claim 4, wherein the arcuate tuck lies in about a center of the area for protection of the head.

6. The safety system of claim 4, wherein the arcuate tuck has a circular or an elliptical shape.

7. The safety system of claim 2, wherein the area for protection of the head includes a rear portion for protection of the head.

8. The safety system of claim 1, wherein the area for protection of the thorax includes a rear side and a bottom, and wherein the rear side tapers continuously from the bottom to the area for protection of the head.

9. The safety system of claim 1, wherein the area for protection of the thorax includes a lower section, a rear side, and a front side, and wherein the area for protection of the thorax tapers at the rear side in the lower section and runs at least approximately parallel to the front side to the head chamber.

10. The safety system of claim 1, wherein the area for protection of the thorax includes a bottom section and a rear side, and wherein the bottom section tapers continuously from the rear side toward the area for protection of the head.

11. The safety system of claim 1, further comprising a gas inlet provided in a bottom part of the area for protection of the thorax.

12. The safety system of claim 1, wherein the air bag includes a first part and a second part, and wherein the first part and the second part are joined by a hem.

13. The safety system of claim 1, wherein the air bag is fastened to a seat, a seat back, a vehicle pillar, or a vehicle door.

14. A safety system for an occupant of a motor vehicle, comprising:
an air bag for protection of the head and thorax areas of the occupant, wherein the air bag includes an area for protection of the thorax and an area for protection of the head;
wherein the area for protection of the thorax includes an upper section, and wherein the upper section includes a rearward extent configured to permit a safety belt to run uninhibited; and
wherein the area for protection of the head is configured to extend substantially above the shoulder belt and further rearward than the upper section of the area for protection of the thorax.

15. A side airbag for protecting the thorax and the head of a passenger of a vehicle, comprising:
a head protecting section located above a thorax protecting section;
wherein the width of the thorax protecting section in the direction of vehicle travel gradually tapers from a bottom of the airbag toward the head protecting section to thereby provide space for a shoulder belt to pass over the occupant.

16. The airbag of claim 15, wherein a rear side of the thorax protecting section tapers more than a front side.

17. The airbag of claim 15, wherein the head protecting section spirals around a seam.
